(19) United States
(12) Patent Application Publication
(10) Pub. No.: US 2008/0062251 A1
(43) Pub. Date: Mar. 13, 2008

(54) Portable terminal device

(75) Inventor: Yoshinori Yuki, Fuchu-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/600,428

(22) Filed: Nov. 16, 2006

(30) Foreign Application Priority Data
Aug. 11, 2006 (JP) 2006-220369

(51) Int. Cl. H04N 7/14

(52) U.S. Cl. 348/14.02

(57) ABSTRACT

A portable terminal device, having a video phone function of transmitting and receiving videos and sounds to and from other portable terminal device, transmits data of a prescribed contents after deteriorating the data thereof when transmits the data thereof to the other portable terminal device during the use of the video phone function.

### CROSS-REFERENCE TO RELATED APPLICATIONS

This application is based upon and claims the benefit of priority from prior Japanese Patent Application No. 2006-220369, filed Aug. 11, 2006, the entire contents of which are incorporated herein by reference.

### BACKGROUND OF THE INVENTION

1. Field of the Invention

The present invention relates to a portable terminal device, such as a portable telephone set, and more specifically, the invention relates to a portable terminal device having a video phone function.

2. Description of the Related Art

In recent years, it has become possible for the portable telephone set to download music and it also has become possible for the portable telephone set to reproduce the music. From such a background, a user of the portable telephone set demands such a technique that enables transferring the music obtained through download or favorite music, etc., to a user of other portable telephone set. Conventionally, among users of the portable telephone sets, when each user mutually transferring the music obtained through the download or the favorite music, etc., for instance, the following methods have been employed.

(Conventional Method 1) Transfers the song titles of the relevant music and Transfers an URL, etc., of a provider from which the relevant music itself can be downloaded, by telephone or e-mail, etc.

(Conventional Method 2) Transfers a play list including information in relation to music IDs of the relevant music (identifiers assigned for each piece of music by provider), song titles, names of artists, and the like (hereinafter, referred to music information) through a mail transmission. Taking copyright, etc., into consideration, music cannot be directly transmitted and received among the portable telephone sets.

Meanwhile, as for a technique relating to telephone and music, a communication sound producing device capable of making communications while listening a background sound is disclosed, for instance, in Jpn. Pat. Appln. KOKAI Publication No. 2006-81051. The communication sound producing device disclosed in Jpn. Pat. Appln. KOKAI Publication No. 2006-81051 generates the background sound during communications, and mixes a communication voice of an opponent party with the background sound to output it from a loud-speaker of its own generating device as well as mixes the background sound with a communication voice of its own generating device to output it to an opponent party destination.

The aforementioned “conventional method 1” and the aforementioned “conventional method 2”, which are pointed out as methods for transferring the music obtained by the user through the download and the favorite music, etc. to the user of other portable telephone terminal, include the following problems.

That is, the foregoing “conventional method 1” and the forgoing “conventional method 2” can make the users of the portable telephone sets transfer only meta-information on the above-described music information, etc. Accordingly, the user who has received such information cannot actually know what the type of the relevant music is like. That is to say, the “conventional method 1” and the “conventional method 2” cannot make the users come to know that what the concerned music is like until they actually download the music.

Under the present circumstances, regarding contents with copyright stored in the portable telephone set, only the meta-information on the foregoing music information can be shared with the users of the other portable telephone sets.

In certain cases, the user may audition the music before the user purchases the concerned music from the provider, etc.; however, audition reproducing only a part of the music, the user cannot listen the part which the user actually confirm sometimes. Further, even such audition becomes subject to accounting (download fee, etc.).

By the way, in recent years, the portable telephone set having so-called a video phone function has been prevailed, taking a present use frequency of the video phone function, to appeal the video phone function to the user in future, a new service of the video phone function and a little extra, and a portable telephone set responding to the new service are desired.

### BRIEF SUMMARY OF THE INVENTION

The present invention has been invented in view of the aforementioned situation, an object of the present invention is to provide a portable telephone terminal capable of transferring, that what contents of music, etc., stored in a portable terminal device such as a portable telephone set, etc., are actually like, to users of the other portable terminal devices and also capable of responding to a service such that promotes distributions of the contents.

To establish the given object, a portable terminal device in a first embodiment of the present invention is one that has a communicating other portable terminal device, and has a transmitting unit configured to transmit a data of contents, and has the data of contents including a video data, and has a deterioration processing unit configured to deteriorate the data of contents when transmitting the data of contents to the other portable terminal device.

To achieve the given object, a portable terminal device in a second embodiment of the present invention is one that has a communicating other portable terminal device, and has a recording unit configured to record a data; and has a control unit configured to control to inhibit the data of contents from recording in the recording unit when the data of contents is transmitted from the other portable terminal device during the use of the video phone function.

The present invention may provide the portable terminal device capable of transferring what contents of the music, etc., stored in the portable terminal device are actually like to the users of the other portable terminal devices and also capable of responding to the service such that promotes the distributions of the contents.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram depicting a configuration of a portable telephone set regarding one embodiment of the present invention;

FIG. 2A is an exemplary a front view when the portable telephone set regarding the one embodiment of the present invention is opened around 180°;

FIG. 2B is an exemplary side view when the portable telephone set regarding the one embodiment of the present invention is opened around 180°;

FIG. 3A is an exemplary front view when the portable telephone set regarding the one embodiment of the present invention is closed;

FIG. 3B is an exemplary side view when the one portable terminal set regarding the present invention is closed;

FIG. 4A is an exemplary view depicting a display example on a display device;

FIG. 4B is an exemplary view depicting one example of a key arrangement;

FIG. 5A is a first part of an exemplary view depicting a process to transfer what music stored in the portable telephone set regarding the one embodiment of the present invention is like to a user of other portable terminal device;

FIG. 5B is a second part of the exemplary view depicting the process to transfer what music stored in the portable telephone set regarding the one embodiment of the present invention is like to the user of other portable terminal device;

FIG. 5C is a third part of the exemplary view depicting the process to transfer what music stored in the portable telephone set regarding the one embodiment of the present invention is like to the user of other portable terminal device; and

FIG. 6 is an exemplary view depicting one example of a means to deteriorate a sound quality of music.

### DETAILED DESCRIPTION OF THE INVENTION

Hereinafter, a portable telephone set regarding one embodiment of the present invention will be set forth with reference to the drawings.

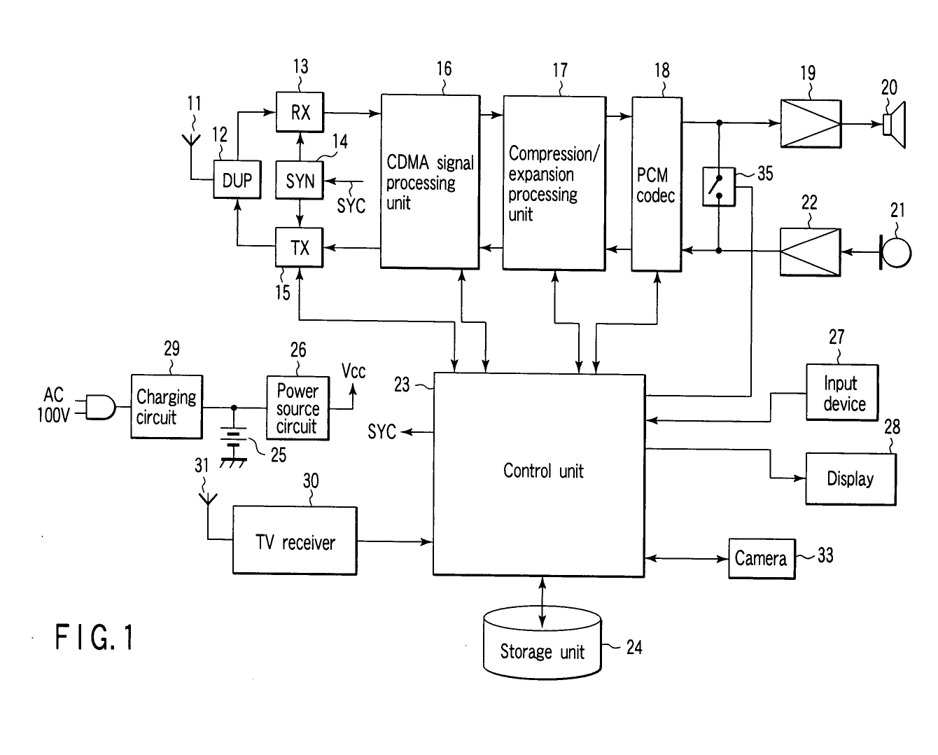

FIG. 1 is a block diagram showing a configuration of the portable telephone set regarding the one embodiment of the present invention.

In FIG. 1, a radio signal transmitted from a base station (not shown) is received by an antenna 11 then input to a receiving circuit (RX) 13 through an antenna duplexer (DUP) 12. The RX 13 mixes the received radio signal with a local oscillation signal output from a frequency synthesizer (SYN) 14 to frequency-convert (down-convert) it into an intermediate signal. The RX 13 then performs quadrature demodulation of the down-converted intermediate frequency to output a received baseband signal. The frequency of the local oscillation signal generated from the SYN 14 is instructed by a control signal SYC output from a control unit 23.

The foregoing received baseband signal is input to a code division multiple access (CDMA) signal processing unit 16. The CDMA signal processing unit 16 has a RAKE receiver. The RAKE receiver each conducts back diffusion processes of a plurality of paths included in the received baseband signal by diffusion codes. The signals of each path conducted the back diffusion processes are arbitrated in their phases to be synthesized. Thus, received packet data of a prescribed transmission format is obtained. The received packet data is input to a compression/expansion processing unit (hereinafter referred to compander) 17.

The compander 17 demultiplexes the received packet output from the CDMA signal processing unit 16 for each medium by a multiplexing/demultiplexing unit. The compander 17 then conducts each decoding processing to the data for each demultiplexed medium. The compander 17, for instance, in a speech mode, decodes audio data, such as a speech voice included in the received packet data, by speech codec (coder-decoder).

The portable telephone set regarding the one embodiment of the present invention has a so-called video phone function. Like video phone, if video data is included in the received packet data, the compander 17 decodes the video data by a video codec.

A digital audio signal obtained through the aforementioned decoding processing is supplied to a PCM code processing unit (hereinafter, referred to PCM codec) 18. The PCM codec 18 PCM-decodes the digital audio signal output from the compander 17 to output an analog audio signal. The analog audio signal is amplified by a reception amplifier 19 then output from a loud-speaker 20.

When an audio reproduction mode has been set, the control unit 23 reads out the corresponding audio contents from a storage unit 24 to conduct a decode-process then loud-outputs through the loud-speaker 20 via the PCM codec 18 and the reception amplifier 19.

The digital video signal decoded by the compander 17 is input to the control unit 23. The control unit 23 displays the digital video signal output from the compander 17 onto a display 28 through a video RAM. The control unit 23 displays not only the received video data but also video data imaged by the below-mentioned camera 33 onto the display 28 through the video RAM.

If the received packet is e-mail, the compander 17 supplies the e-mail to the control unit 23. The control unit 23 stores the e-mail in the storage unit 24. The control unit 23 reads out the e-mail from the storage unit 24 in response to a display operation conducted by the user through an input device 27 to display the e-mail onto the display 28.

In contrast, in the speech mode, a voice signal of a speaker input to a microphone 21 is amplified up to an appropriate level by a transmission amplifier 22, then, performed a PCM coding process by the PCM codec 18 to become a digital audio signal, and input to the compander 17. The video signal output from the below-mentioned camera 33 is digitized by the control unit 23 to be input to the compander 17. The e-mail created by the control unit 23 is also input to the compander 17 from the control unit 23.

The compander 17 detects an energy amount of an input sound from the digital audio signal output from the PCM codec 18 to decide a transmission data rate on the basis of the detection result. The compander 17 encodes the digital audio signal into a signal in a format according to the transmission data rate. Thereby, the compander 17 generates audio data. The compander 17 encodes the digital video signal output from the control unit 23 to generate video data. The compander 17 packetizes the audio data and the video data by the multiplexing/demultiplexing unit in accordance with a prescribed transmission format to output the transmission packet data to the CDMA signal processing unit 16. Even if the e-mail is output from the control unit 23, the compander 17 multiplexes the e-mail onto the transmission packet data.

The CDMA signal processing unit 16 performs a spectrum diffusion process to the transmission packet data output from the compander 17 by using the diffusion codes assigned to transmission channels. The CDMA signal processing unit 16 outputs the output signal to a transmitting circuit (TX) 15. The TX 15 modulates the spectrum-diffused signal by using a digital modulation system such as a quadrature phase shift keying (QPSK) system. The TX 15 synthesizes the transmission signal generated through the modulation with the local oscillation signal generated form the SYN 14 to frequency-convert it into a radio signal. The TX 15 then high-frequency-amplifies the radio signal so as to become a transmission power level instructed from the control unit 23. The amplified radio signal is supplied to the antenna 11 through the DUP 12 to be transmitted toward the base station (not shown) from the antenna 11.

The portable telephone set regarding the one embodiment of the present invention has a television receiver (hereinafter, referred to as TV receiver) 30. The TV receiver 30 receives, for example, a terrestrial television broadcast signal via an antenna 31, and also demodulates the received television broadcast signal to convert it into a digital video signal and a digital audio signal. The digital video signal is displayed onto the display 28 by the control unit 23. The digital audio signal is supplied to the PCM codec 18 from the control unit 23 to be converted into an analog audio signal by means of the PCM codec 18, then, output from the loud-speaker 20 through the reception amplifier 19.

The TV receiver 30 also has a receiving function of an FM broadcast signal. The TV receiver 30 demodulates the received FM broadcast signal to output the digital audio signal. The digital audio signal is supplied to the PCM codec 18 from the control unit 23, as like the digital audio signal demodulated from the television broadcast signal, converted into the analog video signal by the PCM codec 18, and then, output from the loud-speaker 20 through the reception amplifier 19. When an earphone is connected to an earphone terminal (not shown), the sound signal output from the PCM codec 18 is output from the earphone in place of the loud-speaker 20.

A power source circuit 26 generates a prescribed operation power voltage Vcc from an output of a battery 25 to each circuit unit. The battery 25 is charged by a charging circuit 29.

Meanwhile, the control unit 23 has, for instance, a central processing unit (CPU). As operation control being characteristic of the portable telephone set regarding the one embodiment of the present invention, the following operation control is mainly pointed out.

At first, during the use of the video phone set, when transmitting the data of the prescribed contents to other portable telephone terminal, the control unit 23 deteriorates the data of the predetermined contents. During the use of the video phone function, when the data of the prescribed contents is transmitted from the other portable telephone unit to the corresponding portable telephone set, the control unit 23 performs the control to inhibit the recording of the data of the prescribed contents in the storage unit 24. Furthermore, during the use of the video phone function, when receiving the notice of the fact that the other portable telephone set transmits the data of the prescribed contents to the concerned portable telephone set, the control unit 23 transmits a signal showing that the concerned portable telephone set is one responded to the reception of the data of the aforementioned prescribed contents to the other portable telephone set.

By the way, the camera 33 is one to conduct imaging. In the portable telephone set regarding the one embodiment of the present invention, the video data as a display video in the video phone set, is imaged and obtained by means of the camera 33.

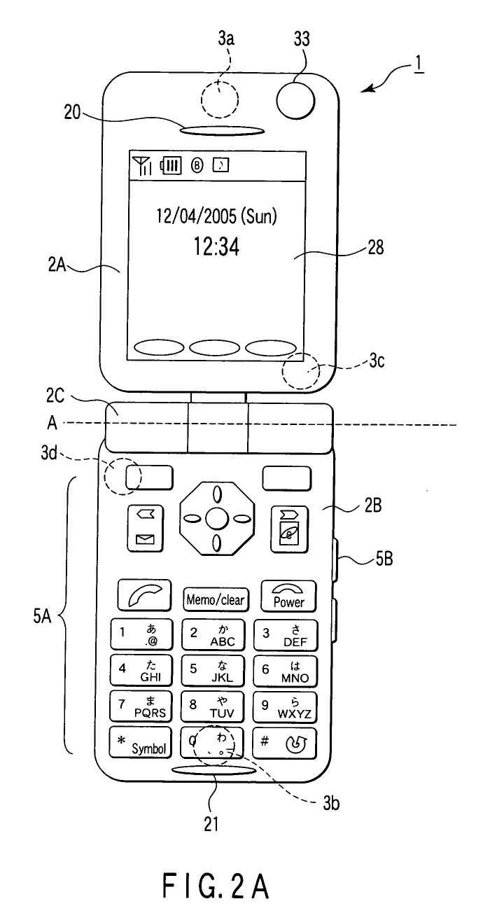

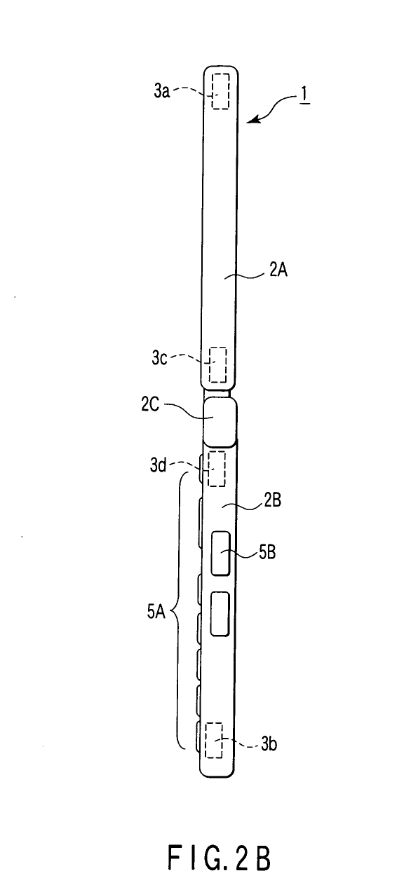

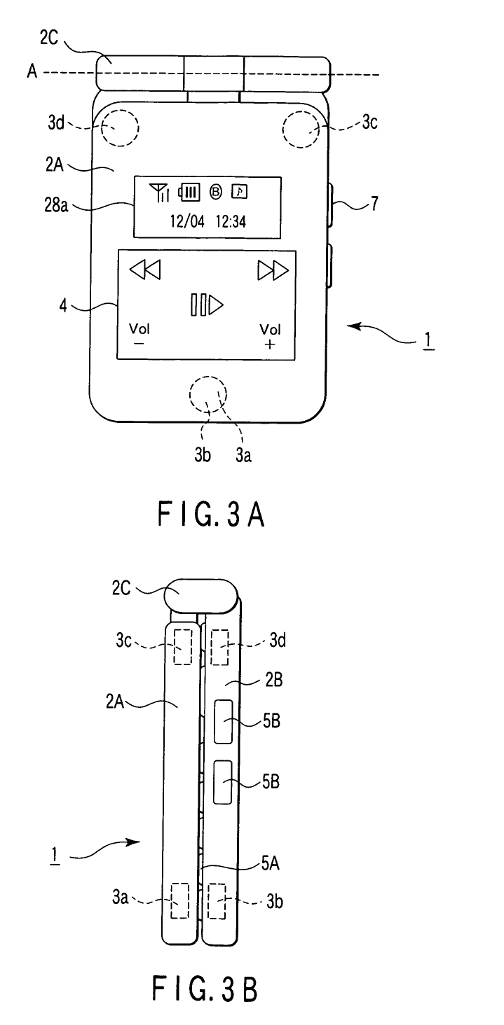

Hereinafter, one example of the outer appearance of the portable telephone set regarding the one embodiment of the present invention will be described by referring to FIGS. 2A, 2B and FIGS. 3A, 3B.

Here, FIG. 2A is a front view in which a portable telephone set 1 is opened by around 180°. FIG. 2B is a side view in which the telephone set 1 is opened by around 180°. FIG. 3A is a front view in which the telephone set 1 is closed. FIG. 3B is a side view in which the telephone set 1 is closed. Here, in the telephone set 1, an upper housing part 2A and a lower housing part 2B are connected through a hinge part 2C.

The upper housing part 2A includes the display 28 composed of an LCD, etc., the loud-speaker 20 as a receiver to generate the received sound, magnetic sensors 3a and 3c to sense the state of the telephone set 1, the camera 33, a sub-display 28a composed of an LCD, etc., and an electrostatic touch pad 4.

Here, the sub-display 28a and the electrostatic touch pad 4 are arranged on the same plane of the upper housing part 2A. Similarly, the loud-speaker 20, the display 28, and the camera 33 are disposed on the same plane of the upper housing part 2A.

The lower housing part 2B has keys 5A to input numeric characters, characters, operations of the telephone set 1 and the like, side keys 5B, a microphone to collect sounds (in FIG. 2A, indicating a transmission mouse) 21, and magnetic sensors 3b and 3d to detect the state of the telephone set 1. The key 5A and the side key 5B shown in FIG. 2A and FIG. 2B, are respond to the input device 27 shown in FIG. 1.

The magnetic sensors 3a and 3d disposed at the upper and the lower housing parts 2A and 2B output detection signals when the sensors 3a and 3b are brought into a state in which they become close to each other within a predetermined distance. Here, a pair consisting of the magnetic sensor 3a and the magnetic sensor 3b among each sensor 3a to 3d is one to detect whether or not the upper and the lower housing parts 2A and 2B are overlapped with each other.

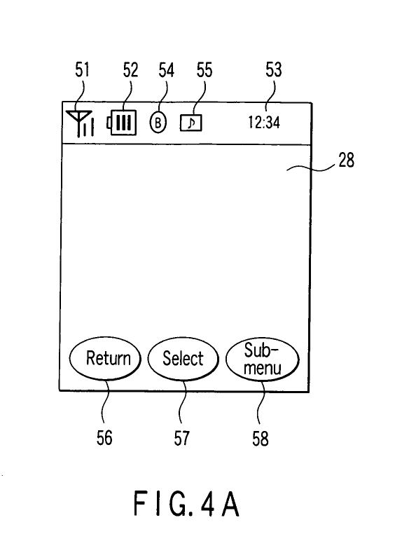

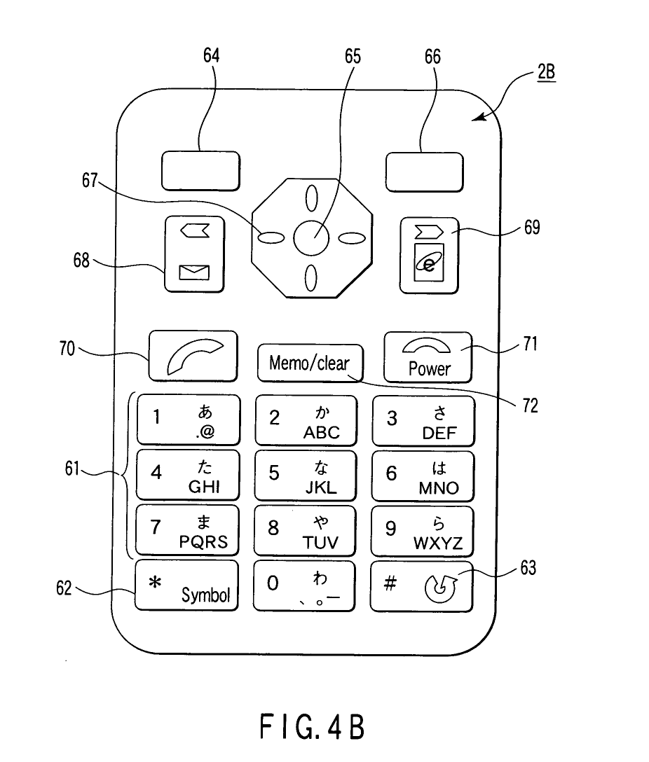

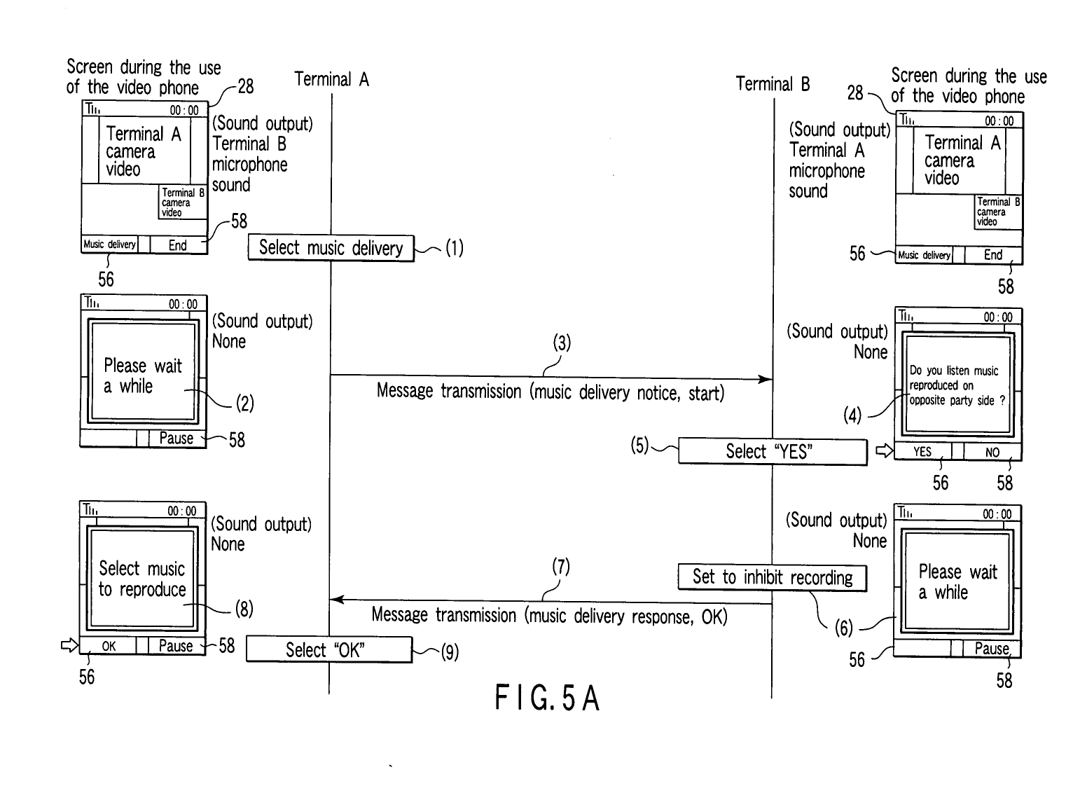

Hereinafter, a display example of the display 28 and an arrangement example of the key 5A will be set forth. Here, FIG. 4A is a view showing a display example of the display 28. FIG. 4B is a view showing an arrangement example of the key 5A.

As shown in FIG. 4A, on the display 28, on the uppermost line (hereinafter, referred to as upper PICT (picture)) line); an antenna PICT 51 indicating a level of sensitivity of the present antenna 11, a battery PICT 52 indicating the present battery remaining quantity of the telephone set, a time display 53 indicating the present time, a Bluetooth (BT, registered trade mark) icon 54 displayed during initiation of the BT, and a music icon 55 displayed, for instance, during initiation of a music player (hereinafter, referred to as MP); are displayed.

During the connection of the BT, in the BT icon 54, the background of which, is displayed in blue (inside ellipse of FIG. 4 is colored in blue). In a server operation (BT connection waiting state), the BT icon 54 is indicated in white (inside ellipse of FIG. 4 is colored in white). When the BT connection is not performed (including the case of shutdown of BT link), the BT icon 54 is controlled so as to be turned off.

When the MP is activated as described above, the music icon 55 is displayed. The music icon 55 is also displayed in the time when the MP is reproduced as background (hereinafter, referred to as BGM). In the case of other than this, the music icon 55 is turned off through the control by the control unit 23.

Meanwhile, on the lowermost line (hereinafter, referred to as lower PICT line) on the display 28, at the relevant time point, a simple description of functions executed in the case of pressing operations of a soft-key left 64, a decision key 65 (central part of cross key 67), and a soft-key right 66 are indicated as a left lower PICT 56, a middle lower PICT 57, and a right lower PICT 58.

Here, the left lower PICT 56, the middle lower PICT 57, and the right lower PICT 58 are responded to the soft-key left 64, the decision key 65, the soft-key right 66, respectively.

For instance, if the display shown in FIG. 4A is performed on the display 28, the pressing operation of the soft-key left 64 executes a function of “return”. The pressing operation of the decision key 65 selects a function being in focus now, although it is not shown in FIG. 4A. Pressing and operating the soft-key right 66, “sub-menu” is displayed on the display 28.

By the way, as shown in FIG. 4B, the lower housing part 2B has numeric character keys 61, a “” key 62, a “#” key 63, a soft-key left 64, a decision key 65, a soft-key right 66, a cross-key 67, a mail key 68, a browser key 69, a speech key 70, a power key 71, and a clear key 72.

Here, Japanese “KANA” characters, symbolic characters, alphabets, etc., other than the numeric characters are assigned to the numeric character keys 61. For example, to the key of “1”, a numeric character “1”, “KANA” characters of “a”, “i”, “u”, “e” and “o”, and symbols of “.” and “@” are assigned. A numeric character “2”, Japanese “KANA” characters of “ka”, “ki”, “ku”, “ke” and “ko”, and alphabets of “A”, “B”, “C”, “a”, “b”, “c”, etc., are assigned to, for instance, the key of “2”.

To the “” key 62, a symbol “” is assigned. The “” key 62 is also one to call a symbol list and an icon list in a character input status. A symbol “#” is assigned to the “#” key 63. In the character input status, the “#” key 63 is also one to inverse a toggle on a character input by the numeric character key 61.

The cross key 67 has an up key, a down key, a left key, a right key, and a decision key 65. Namely, the cross key 67 is a key to move a cursor, etc., toward up, down, right, and left directions. The decision key 65 is one to decide a various functions. The mail key 68 is one to call transmission and reception functions. The browser key 69 is one to connect to Web, etc.

The speech key 70 is one to be used mainly for receiving a telephone call and normally making a transmission. The power key 71 is one mainly to turn on/off a power source, operate for terminating speech, and conduct termination operations of functions, editing, etc. Further, the clear key 72 is one mainly to clear the functions, editing, etc., and delete characters in inputting the characters. While the display 28 displays a standby screen, if the clear key 72 is pressing-operated, a memo pad is called out to be displayed on the display 28.

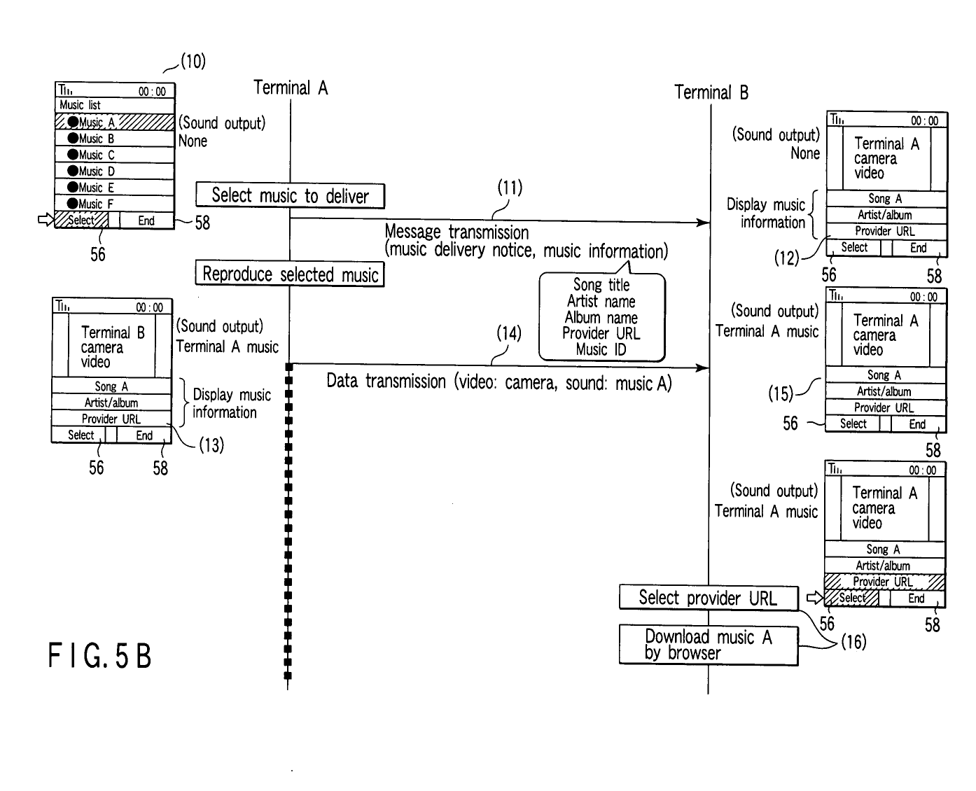

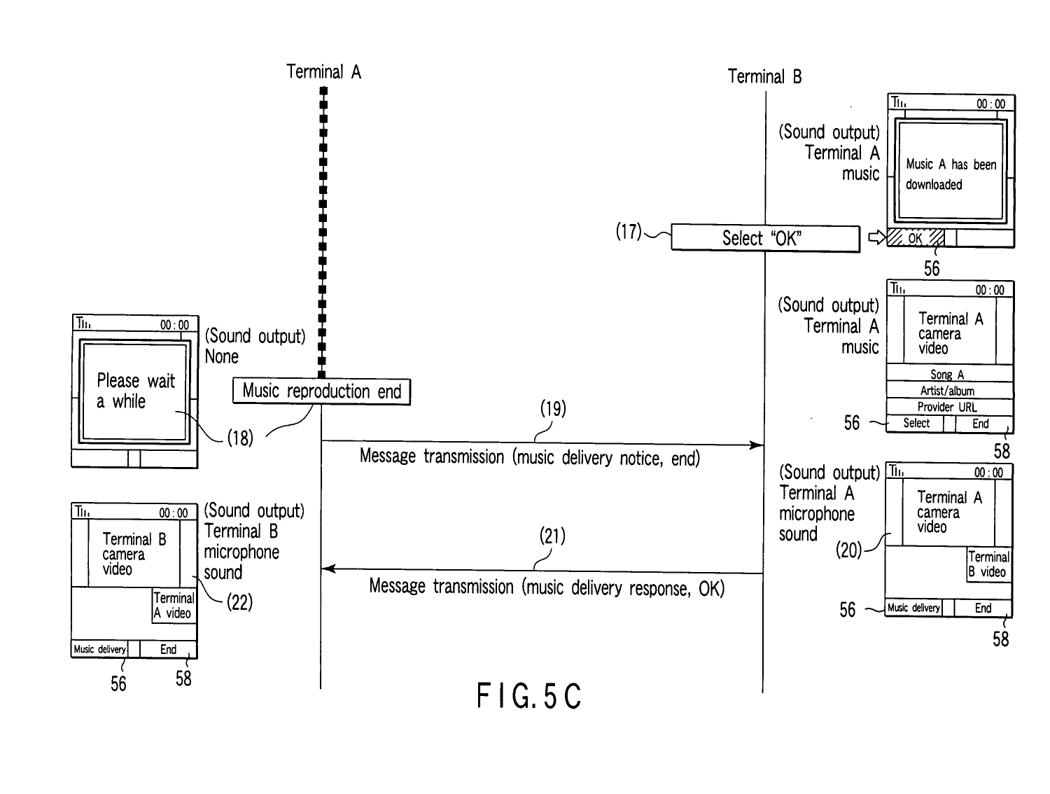

Hereinafter, a process to transfer that what type of music stored on the portable telephone set regarding the one embodiment of the present invention is actually like to the user of the other portable terminal device will be described with reference to FIG. 5A-FIG. 5C.

Here, it is presumed that terminals A and B shown in FIG. 5A-FIG. 5C are both portable telephone sets regarding the one embodiment of the present invention. The detailed operation control in each process going the same that has been described by referring to FIG. 1, here, the process of data transmissions and receptions between the terminals A and B will be focused and described.

At first, it is premised that the terminals A and B are engaged on the video phone. Therefore, between the terminals A and B, videos obtained by the camera 33 and sounds caught from the microphone 21 are transmitted and received to and from each other.

Here, the video displayed on the display 28 of the terminal A engaged on the video phone are referred to as a terminal A displaying video. Similarly, the video displayed on the display 28 of the terminal B engaged on the video phone are referred to as a terminal B displaying video. The video which has been obtained by the terminal A through the camera 33 is called a terminal A camera video. The video which has been obtained by the terminal B through the camera 33 is called a terminal B camera video.

The output sound from the terminal A engaged on the video phone is a sound obtained by the terminal B through the microphone 21 to be transmitted to the terminal A (hereinafter, referred to terminal B microphone sound). Similarly, the output sound from the terminal B engaged on the video phone is a sound obtained by the terminal A through the microphone 21 to be transmitted to the terminal B (hereinafter, referred to as terminal A microphone sound).

Hereinafter, the process of the data transmissions and receptions between the terminal A and the terminal B will be set forth in time series.

The user of the terminal A is called “user A” and the user of the terminal B is called “user B”. Here, in FIG. 5A-FIG. 5C, processes shown at (1)-(21) and processes shown (1)-(21) below are in correspondence relationships with one another.

(1) Operation at Terminal A

The user A becomes possible to conduct a pressing operation of the soft key left 64 at the terminal A on the basis of a guide display of the left lower PICT 56 displayed as “music delivery” on the display 28. When detecting the pressing operation, the control unit 23 makes the process (1) shift to a process shown at (2). In the process (1), the sound output from the loud-speaker 20 is the terminal B microphone sound.

(2) Status of Terminal A

In the process (2), the control unit 23 controls the display 28 so as to display “Please wait for a while”, and stops a transmission of a video and an output of a sound as a video phone. Then, the process (2) shifts to a process (3).

(3) Message Transmission

In the process (3), the control unit 23 controls to perform a message transmission to the terminal B. In the message transmission, the control unit 23 controls to transmit messages including a “notice of performing of music delivery” and a message (control signal) of “fact of start of music delivery”.

(4) Status of Terminal B

In a process (4), when the terminal B receives a transmitted message from the terminal A in the process (3), the control unit 23 of the terminal B controls to display the fact of “Do you listen the music reproduced on the opposite party side?” on the display 28 to stop the output of the video and sound on the video phone.

(5) Operation at Terminal B

In a process (5), the control unit 23 of the terminal B determines if the pressing operation of the soft key left 64 of the terminal B is conducted on the basis of the guide display of the left lower PICT 56 displaying “YES” on the display 28. Then, if it is determined that the pressing operation of the soft key left 64 is performed, the process (5) shifts to a process (6).

(6) Status of Terminal B

In the process (6), the control unit 23 of the terminal B sets the terminal B so that the terminal B cannot record (record in record unit 24 owned by terminal B) music transmitted from the terminal A after this. When the control unit 23 of the terminal B performs this setting, the terminal B becomes impossible to select, for instance, an item that is “record” displayed in a menu display, etc, by operating the input device 27. Further, the control unit 23 of the terminal B controls to display “Please wait for a while” on the display 28. At this time, the control unit 23 may control so that the terminal B does not output an output sound.

(7) Message Transmission

In a process (7), the control unit 23 of the terminal 23 controls so as to transmit a message to the terminal A. This message includes a message (control signal) of “response of fact of permission of music delivery”, and “fact of delivery start OK”.

In the process (7), in addition to the given message transmission, it is also acceptable that a correspondence terminal signal, that is a signal indicating that the terminal B is the portable terminal set regarding the one embodiment of the present invention (signal of fact of mounting the music transmission function), is transmitted to the terminal A.

(8) Status of Terminal A

In a process (8), when the terminal A receives the message transmitted from the terminal B in the process (7), the control unit 23 of the terminal A controls to display “Please select music to be reproduced” on the display 28. In this process (8), the control unit 23 may control so that the terminal A does not output the sound.

When the terminal B is made to transmit the correspondence terminal signal in the process (7), and if the terminal signal (signal of fact of mounting music transmission function) is not received in the process (8), the control unit 23 of the terminal A controls to display the fact of stoppage of the music delivery onto the display 28 to terminate the process of the music delivery.

(9) Operation at Terminal A

In a process (9), the control unit 23 of the terminal A determines if the pressing operation of the soft key left 64 on the basis of the left lower PICT 56 displayed as “OK” on the display 28, and if the pressing operation of the soft key left 64 is conducted, the process (9) shifts to a process (10).

(10) Operation at Terminal A

In the process (10), the control unit 23 of the terminal A, determines if the operation of the cross key 67 tunes a cursor to desired music (here, for instance, music A), and also determines whether the soft left key 64 performs the pressing operation or not on the basis of the guide of the left lower PICT 56 displayed as “select” (determine whether desired music to be delivered is selected or not). If the control unit 23 of the terminal A determines that the desired music to be delivered is selected, the process (10) shifts to a process (11). In the process (10), the control unit 23 of the terminal A may control it so as not to output the sound.

(11) Message Transmission

In the process (11), the control unit 23 of the terminal A controls to transmit a message to the terminal B. The message includes messages of “fact of information for music delivery notice” and “music information”. The “music information” is information including a song title, an artist name, an album name, a URL of a provider possible to download, a music ID, etc., relating to the music A selected in the process (10).

(12) Status of Terminal B

In a process (12), when the terminal B receives the message transmitted from the terminal A in the process (11), the control unit 23 of the terminal B controls to display music information included in the message and a terminal A camera video as the video phone. In the process (12), the control unit 23 may control the terminal B so as not output the sound.

(13) Status of Terminal A

In a process (13), the control unit of the terminal A controls to reproduce the music A selected in the process (10) to output the music A from the loud-speaker 20 of the terminal A. The control unit 23 of the terminal A controls so as to display music information of the music A and a terminal B camera video as the video phone on the display 28.

(14) Message Transmission

In a process (14), the control unit 23 of the terminal A controls so as to transmit a data transmission of the music for delivery selected in the process (10) to the terminal B. The transmission data in the process (14) includes the data of the camera video imaged by the camera 33 of the terminal A and the data of the selected music A being in reproduction. The control unit 23 of the terminal A may control the tone quality of the music A to deteriorate from its original tone quality by the below-described method in the data transmission in the process (14). The control unit 23 of the terminal A controls so that the data transmission in the process (14) is repeated until the reproduction of the music A ends, or until the user A performs a prescribed operation to stop the reproduction of the music A.

Hereinafter, a method for deteriorating the tone quality of the music will be made clear.

At first, as a first method, a change in a data compression method is pointed out. More specifically, for instance, if the original compression method of the music is aacPlus, changing it to other compression method such as an AAC, AMR and QCELP enables the deterioration of the tone quality of the relevant music.

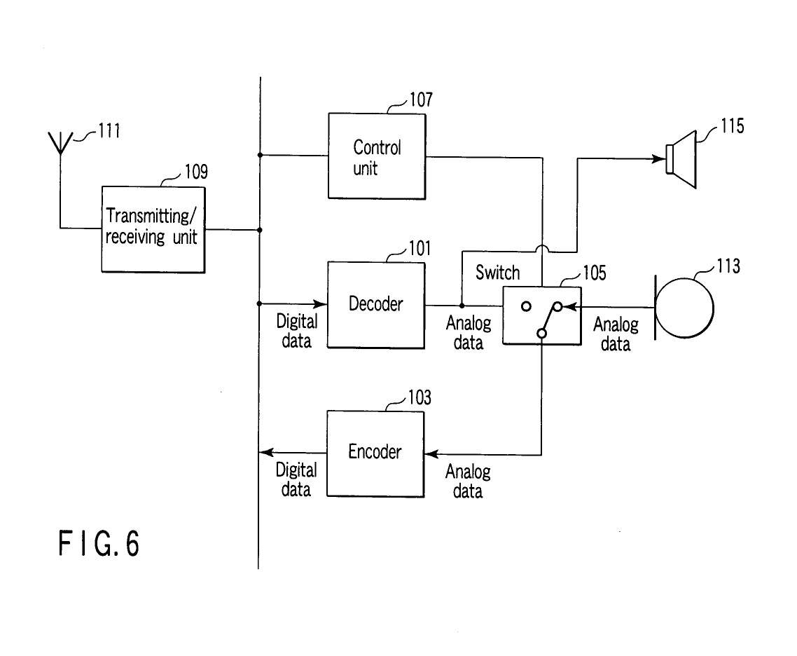

As a second method, a method for deteriorating the tone quality of the music by repeating a DA conversion and an AD conversion in such simple manner likes “digital-analog-digital”. Hereinafter, the second method will be specifically described by referring to FIG. 6. Here, FIG. 6 is a block diagram showing a part of a configuration of the portable telephone set of the one example of the present invention. The correspondence relationships between constituent members in the block diagram shown in FIG. 6 and the constituent members in the block diagram shown in FIG. 1 are as follows.

That is, a decoder 101 and an encoder 103 shown in FIG. 6 are each corresponds to the compander 17 shown in FIG. 1. A switch 105 shown in FIG. 6 corresponds to the switch 35 shown in FIG. 1. A control unit 107 shown in FIG. 6 corresponds to the control unit 23 shown in FIG. 1. A transmitting/receiving unit 109 shown in FIG. 9 corresponds to the DUP 12, RX 13, SYN 14 and TX 15 shown in FIG. 1. An antenna 111 shown in FIG. 6 corresponds to the antenna 11 shown in FIG. 1. A microphone 113 shown in FIG. 6 corresponds to the microphone 21 shown in FIG. 1. A loud-speaker 115 shown in FIG. 6 corresponds to the loud-speaker 20 shown in FIG. 1.

To perform the DA conversion and the AD conversion to the music as mentioned above, the decoder 101, as shown in FIG. 6, converts digital data into analog data, then, the encoder 103 converts the analog data into the digital data again. At this time, undoubtedly, the switch 105 has been switched to the side to connect the decoder 101 and the encoder 103 with each other.

(15) Status of Terminal B

In a process (15), when the terminal B receives the data transmitted from the terminal A in the process (14), the control unit 23 of the terminal B controls so as to display the music information included in the message, and the camera video imaged by the camera 33 of the terminal A (as video phone) onto the display 28. The control unit 23 of the terminal B, at this time, conducts reproduction control of the music A to output it from the loud-speaker 20.

(16) Operation at Terminal B

In a process (16), the control unit 23 of the terminal B determines whether or not the pressing operation of the soft key left 64 is conducted on the basis of the guide in which the cursor is tuned to “provider URL” and also displayed as “select” at the left lower PICT 56 of the display 28 among the music information displayed on the display 28 by the operation of the cross key 67 of the terminal B. When determining that the cursor is tuned to the “provider URL” and also the pressing operation of the sift key left 64 is conducted, the control unit 23 of the terminal B controls so as to download the music A from the provider indicated by the “provider URL”.

(17) Operation at Terminal B

Next to this, in a process (17), the control unit 23 of the terminal B determines whether or not the music A has completely downloaded. If it is determined that the download of the music A has completed, the control unit 23 of the terminal B makes the display 28 display the fact of the completion of the download, and also determines whether or not the pressing operation of the soft key left 64 has been done on the basis of the guide displayed as “OK” at the left lower PICT 56 of the display 28.

When determining that the pressing operation of the soft key left 64 is conducted, the control unit 23 of the terminal B then controls again so that the display 28 displays the music information included in the message and the camera video imaged by the camera 33 of the terminal A (as video phone).

(18) Status of Terminal A

Next, in a process (18), when the reproduction of the music A comes to end, or when the user A performs a prescribed operation to stop the reproduction of the music A, the control unit 23 of the terminal A controls the display 28 to display “Please wait for a while”. The control unit 23 may stop a display of the terminal B camera and the sound output therefrom as the video phone.

(19) Message Transmission

Next, in a process (19), the control unit 23 of the terminal A controls so as to conduct a message transmission to the terminal B. The message at this message transmission includes “fact of a notice related to music delivery” and “fact of terminating music delivery”.

(20) Status of Terminal B

Next, in a process (20), when the terminal B receives the message transmitted from the terminal A in the process (19), the control unit 23 of the terminal B controls to store the music information in the storage unit 24. The control unit 23 of the terminal B then controls to stop the reproduction of the music A.

Here, the display 28 displays the camera video imaged by the camera 33 of the terminal A and the camera video imaged by the camera 33 of the terminal B, as the video phone. The camera video imaged by the camera 33 of the terminal A is displayed as a main video which is larger than the camera video imaged by the camera 33 of the terminal B. The control unit 23 of the terminal B controls so as to output the sound transmitted from the terminal A through the loud-speaker 20. That is, the status of the terminal B returns to the state of the video phone before shifting to the music delivery.

(21) Message Transmission

Next, in a process (21), the control unit 23 of the terminal B controls to perform a message transmission to the terminal A. The message in this message transmission includes a message of “signal of fact of response related to music delivery” and “signal of fact of acknowledgement to terminate”.

(22) Status of Terminal A

Next, in a process (22), when the terminal A receives the message transmitted from the terminal B in the process (20), the control unit 23 of the terminal A controls to display the camera video imaged by the camera 33 of the terminal B and the camera video imaged by the camera 33 of the terminal A on the display 28, as the video phone. Here, the camera video imaged by the camera 33 of the terminal B is, as a main video, displayed larger than the camera video imaged by the camera 33 of the terminal A. The control unit 23 of the terminal A controls to output the sound transmitted from the terminal B through the loud-speaker 20. That is, the terminal A returns to the status of the video phone before shifting to the music delivery.

In the processes from (2) to (12), the sound outputs may not be conducted as the sound information of the video phone, and on the contrary, it may be conducted. When performing the sound output, the sound information of the video phone results in outputting at the same time of outputting of music (music A in one embodiment of the present invention).

As described above, according to the one embodiment of the present invention, the portable terminal device can be provided, wherein the portable terminal device can transfer, that what the contents of the music, etc., stored in the portable terminal device such as a portable telephone set are actually like, to the user of the other portable terminal device, and also can respond a service to promote distributions of the contents. As for such contents, for instance, movie contents, etc., other than music are taken into account.

More specifically, according to the portable telephone set regarding the one embodiment of the present invention, for instance, in transferring information on the music recorded and stored in the portable telephone set to the user of the other portable telephone set, as described by referring to FIG. 5A-FIG. 5C, the music can be actually reproduced and transferred by the portable telephone set of the opposite party under taking the copyright of the music into account. Therefore, according to the portable telephone set regarding the one embodiment of the present invention, the user of the other portable telephone set can know that what the music is actually like before downloading it.

Namely, according to the one embodiment of the present invention, the portable telephone set can be provided, wherein the portable telephone set, in addition to improve the convenience of the music delivery service, can take out the information on the contents such as music stored in each portable telephone set among mutual portable telephone sets, and corresponds to a service to promote distributions of the contents of the music, etc.

In the one embodiment of the present invention, as given above, with the recording inhibition control on the reception side and the deterioration processing on the transmission side of the music, it becomes possible to directly transmit and receive the music among the portable telephone sets and to reproduce the music during speech, which have conventionally been impossible on account of taking the copyrights into consideration.

Having described on the present invention on the basis of the one embodiment thereof, the present invention is not limited to the forgoing embodiments; it is of course that a variety of modifications and applications may be made without departing from the principle of the present invention.

For example, in terms of the output sound from the terminal A in the process (13), of course, the sound, in which the music A during in reproduction and the terminal B microphone sound are mixed with each other, may be used. Thereby, the user A becomes possible to respond requests for, for instance, fast forwarding or rewinding of the music during reproduction, and reproducing from any position from the user B just on the video phone.

In the one embodiment of the present invention, for the sake of convenience, having presumed and described the video phone system of a one-to-one correspondence of the video phones, it is undoubtedly acceptable to apply the foregoing embodiment to a video phone system of a one-to-N correspondence.

As mentioned above, for instance, if it is possible to actually reproduce the music stored in a memory of the portable telephone set to transfer the music to the portable telephone set of the opposite party, the sharing of the music in real time becomes possible temporally, and the user of the portable telephone set on the destination side of the transmission can actually come to know what the type of the music is like before downloading the music.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable terminal device communicating other portable terminal device, comprising:
a transmitting unit configured to transmit a data of contents, the data of contents including a video data,
a deterioration processing unit configured to deteriorate the data of contents when transmitting the data of contents to the other portable terminal device.

2. The portable terminal device according to claim 1, wherein
the deterioration processing unit changes a data compression method of the data of contents so as to deteriorate the data of contents.

3. The portable terminal device according to claim 1, wherein
the deterioration processing unit performs an analog conversion and a digital conversion for the data of contents at least once each so as to deteriorate the data of contents.

4. A portable terminal device communicating other portable terminal device, comprising:
a recording unit configured to record a data; and
a control unit configured to control to inhibit the data of contents from recording in the recording unit when the data of contents is transmitted from the other portable terminal device during the use of the video phone function.

5. The portable terminal device according to claim 4, wherein
the control unit transmits a signal indicating that the aforementioned portable terminal device is a portable terminal device corresponded to a reception of the data of contents to the other portable terminal device when receiving a notice of the fact of transmitting the data of contents from the other portable terminal device during the use of the video phone function.

6. The portable terminal device according to claim 4, further comprising:
a reproducing unit configured to reproduce the data of contents after the data of contents has been sent; and
a display unit configured to display a music information related to the data of contents, after the data of contents has been sent.

7. The portable terminal device according to claim 6, wherein
the display unit displays images sent from another portable terminal device.

8. The portable terminal device according to claim 6, wherein
the music information includes a link information, the link information representing a source from which the data of contents is to be acquired.
